(19) United States
(12) Patent Application Publication
(10) Pub. No.: US 2008/0129271 A1
(43) Pub. Date: Jun. 5, 2008

(54) Low Voltage Reference System

(75) Inventor: John A. Fifield, Underhill, VT (US)

Correspondence Address: DOWNS RACHLIN MARTIN PLLC, 199 MAIN ST, PO BO 190, BURLINGTON, VT, 05402-0190, US

(73) Assignee: INTERNATIONAL BUSINESS MACHINES CORPORATION, Armonk, NY (US)

(21) Appl. No.: 11/566,503

(22) Filed: Dec. 4, 2006

(51) Int. Cl. G05F 3/16

(52) U.S. Cl. 323/313

(57) ABSTRACT

A voltage reference system that generates a stable reference voltage at varying supply voltages. The system receiving an input voltage and having a voltage pumping circuit that provides a power supply, regulated by a regulator circuit, to a bandgap reference circuit. The bandgap reference circuit generating a first output as a stable voltage value and delivering the first output to a clamping circuit which outputs the lesser of the stable voltage value and a fraction of the input voltage.

### FIELD OF THE INVENTION

The present invention generally relates to the field of integrated circuits. In particular, the present invention is directed to a voltage reference circuit for low volt applications.

### BACKGROUND

The drop in integrated circuit (IC) supply voltage to levels at or below 1 Volt approaches, or in some cases is less than, the Vbe voltage of P-N junction diodes, which can be as high as 0.8 volts at −40 C. These diodes commonly appear in bandgap reference circuits and the convergence of the diode Vbe voltage and supply voltage often creates unpredictable bandgap reference levels, especially at low temperature. Unfortunately, IC designers are limited in the manner in which the voltage convergence issue may be addressed. Many applications, for example, do not allow temperature restrictions that might provide an operating range less than 0.5 Volts. Further, although resistor circuits may be used in place of bandgap reference circuits, these resistor circuits provide output voltage that linearly tracks the IC supply voltage. Consequently, an IC system is needed that will deliver a stable reference voltage and/or reference current at low supply voltages.

### SUMMARY

In one embodiment, a voltage reference system is provided. The reference system includes a bandgap reference circuit having a first output and a voltage pumping circuit having a second output providing a power supply to the bandgap reference circuit.

In another embodiment, a voltage reference system is provided. The reference system includes a voltage pumping circuit having a first output; a regulator circuit for regulating the voltage pumping circuit by comparing a fraction of Vdd and a fraction of the first output, the first output being a value greater than Vdd; a bandgap reference circuit having a second output and a power supply provided by the first output; and a clamping circuit in electrical communication with the second output and having a third output that is the minimum of the second output and a second fraction of Vdd.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a schematic view of one embodiment of a reference system;

FIG. 2 is a schematic view of another embodiment of a reference system;

FIG. 3 is a schematic view of one embodiment of a bandgap reference circuit; and

FIG. 4 is a plot of simulation results from an embodiment of a reference system.

### DETAILED DESCRIPTION

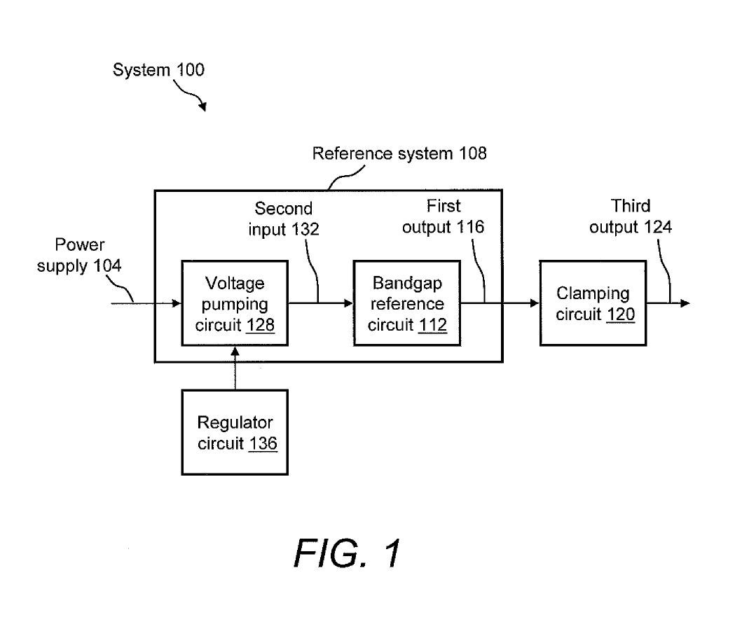

Referring now to the drawings, FIG. 1 illustrates one embodiment of a system 100. At a high level, system 100 may be an electrical circuit, a combination of electrical circuits, or other arrangement of discrete electrical components. The arrangement and design of system 100 may include a power supply 104. Power supply 104 may be applied directly to system 100, transmitted from another functional component in communication with system 100 or generated internally by system 100, as desired. In one example, power supply 104 may be an input voltage (Vdd) having a value greater than 1 V. In another example, power supply 104 may be Vdd having a value below 1 V.

System 100 may include a reference system 108. Reference system 108 may include a bandgap reference circuit 112 that generates a first output 116. Bandgap reference circuit 112 may include any bandgap reference circuit known to those of ordinary skill. In one embodiment, bandgap reference circuit 112 may provide first output 116 as a voltage reference to other electrical components or circuitry. For example, first output 116 may communicate with components used in an ASIC eDRAM (not shown). In another example, first output 116 may communicate with an operational amplifier (op-amp) circuit (not shown). In another embodiment, first output 116 may communicate with a clamping circuit 120. Clamping circuit 120 may compare the value of first output 116 to a fractional portion of power supply 104. In one example, the fractional portion may be a second fraction of Vdd having a value equal to an equation, such as, for example, (0.61*Vdd). Clamping circuit 120 may generate a third output 124 that may be the lesser of the value of first output 116 and the fractional portion of power supply 104.

In general, a stable and predictable value for first output 116 may be needed. Further, a fixed value of first output 116 may become too high for optimum op-amp operation. Those ordinarily skilled in the art will recognize that traditional bandgap circuits may poorly regulate the value of first output 116 when the value of its power supply falls below certain levels. In one example, first output 116 may become unpredictable at a power supply value of 0.9 V.

Reference system 108 may also include a voltage pumping circuit 128. Pumping circuit 128, for example, may be a voltage multiplier circuit, e.g., a voltage doubler circuit. In another example, pumping circuit 128 may be a charge pump. In yet another example, pumping circuit 128 may be a 2× pumping circuit. In general, pumping circuit 128 may receive power supply 104, e.g., Vdd, and generate a second output 132. Second output 132 may have a value corresponding to a value of power supply 104. The value of second output 132 may be equal to a fraction of power supply 104. In one example, the fraction of power supply 104 may equal a value less than 1, e.g., ½. In another example, the fraction of power supply 108 may equal a value greater than 1, e.g., 3/2.

Second output 132 may be regulated to a fraction of Vdd and not to a level proportional to the value of first output 116. For example, providing a second output 132 with a value proportional to the value of first output 116 may create an undesired feedback loop which resolves to 0 V. In another embodiment, the value of second output 132 may be regulated to equal a fixed fraction of Vdd when Vdd equals a minimum expected value. For example, the value of second output 132 may be regulated to a value above 0.8 V at a minimum expected value of Vdd. In yet another example, the value of second output 132 may have a value equal to the equation (1.3*power supply 104). In another example, where power supply 104 is Vdd, the value of second output 132 may have a value equal to the equation (1.3*Vdd).

In an alternative embodiment, voltage pumping circuit 128 may communicate with a regulator circuit 136. Regulator circuit 136 may regulate the value of second output 132. For example, regulator circuit 136 may regulate the value of second output 132 to equal a fixed fraction of power supply 104. In another example, regulator circuit 136 may compare a fractional value of second output 132 and a fractional value of power supply 104. In yet another example, the fractional value of power supply 104 may be a first fraction of Vdd, such as, for example, a first fraction of Vdd having a value equal to the equation (0.55*Vdd).

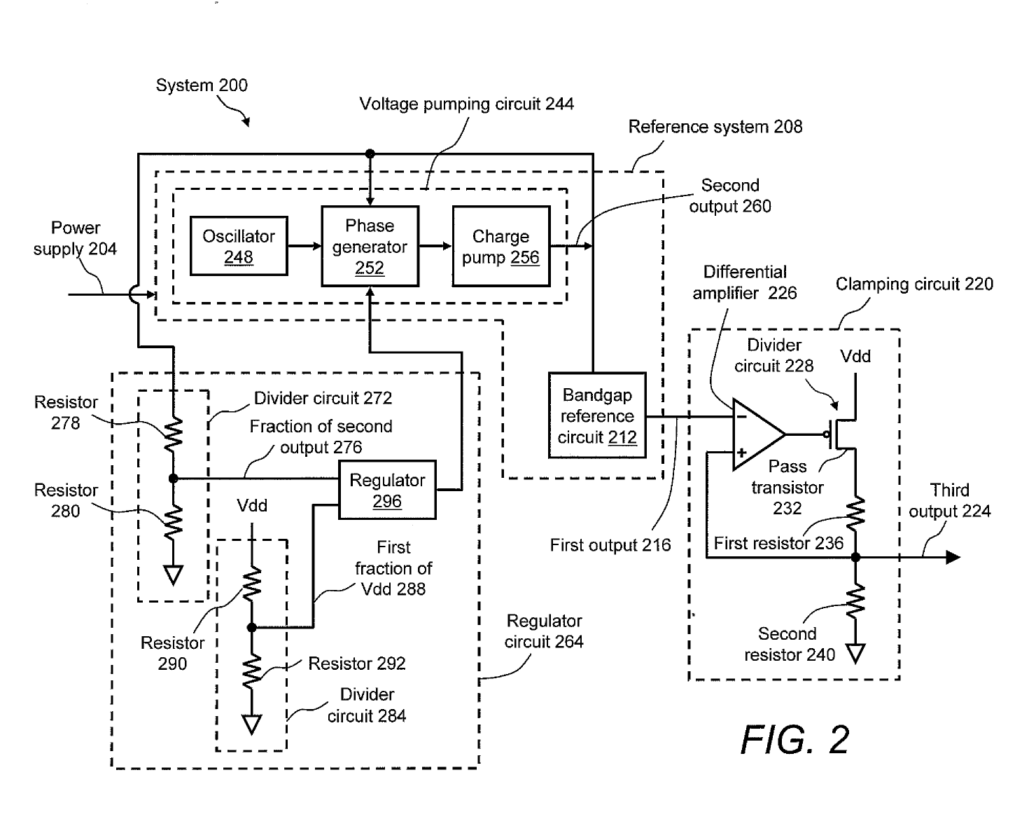

Referring back to the drawings, FIG. 2 illustrates another embodiment of a system 200. In general, system 200 includes a power supply 204, discussed previously. System 200 may also include a reference system 208 having a bandgap reference circuit 212 for generating a first output 216. Bandgap reference circuit 212 may communicate with a clamping circuit 220 that generates a third output 224.

In one embodiment, clamping circuit 220 may include a divider circuit 228 that provides a second fraction of Vdd Divider circuit 228 may include a first resistor (R0) 236 and a second resistor (R1) 240. For example, the second fraction of Vdd may have a value equal to the equation (Vdd*R1/(R0+R1)). In another example, first resistor 236 may have a resistance value of 46 k-ohm and second resistor 240 may have resistance value of 72 k-ohm. Clamping circuit 220 may compare the value of the second fraction of Vdd to the value of first output 216 to generate third output 224. For example, the value of third output 224 may be equal to the lesser of the value of second fraction of Vdd and the value of first output 216. In another example of clamping circuit 220, the first output 216 is coupled to the negative input of a differential amplifier 226 and is compared to the output voltage of divider circuit 228, which provides a second fraction of Vdd. When the first output 216 is at a voltage below the second fraction of Vdd, the negative feedback of differential amplifier 226 controls the gate of a pass transistor 232 to make third output 224 essentially equal to first output 216. When the first output 216 is below the level of the second fraction of Vdd, the pass transistor 232 is turned completely on and third output 224 follows the voltage predicted by the second fraction of Vdd.

Reference system 208 may also include a voltage pumping circuit 244. Voltage pumping circuit 244 may further include an oscillator 248, a phase generator 252 and a charge pump 256. In one embodiment, oscillator 248 drives phase generator 252, which operates charge pump 256 to generate a second output 260. Oscillator 248 may be any oscillator known in the art. For example, oscillator 248 may be a 50 mHz oscillator formed by a string of inverters. Charge pump 256 may be any charge pump known in the art. In one example, charge pump 256 may be a 2× charge pump.

Second output 260 may be regulated by a regulator circuit 264 in communication with voltage pumping circuit 244. In one example, regulator circuit 264 may regulate second output 260 to a value equal to the equation (1.3*power supply 204). In another example, where power supply 204 is Vdd, regulator circuit 264 may regulate second output 260 to a value equal to the equation (1.3*Vdd). Regulator circuit 264 may compare a fraction of second output 260 to power supply 204. In one embodiment, regulator circuit 264 may include a divider circuit 272 that provides a fraction of second output 276. Divider circuit 272 may include a third resistor 278 and a fourth resistor 280. In one example, third resistor 278 may have a resistance value of 112 k-ohm and fourth resistor 280 may have a resistance value of 83 k-ohm. Regulator circuit 264 may also include a divider circuit 284 that provides a first fraction of Vdd 288. Divider circuit 284 may include a fifth resistor 290 and a sixth resistor 292. In one example, fifth resistor 290 may have a resistance value of 16.5 k-ohm and sixth resistor 292 may have a resistance value of 20 k-ohm. Regulator circuit 264 may further include a regulator 296 that receives fraction 276 and first fraction 288. Regulator 296 may compare the value of fraction 276 and first fraction 288 to regulate second output 260. In one example, second output 260 may be regulated to a fixed fraction of Vdd, as discussed previously.

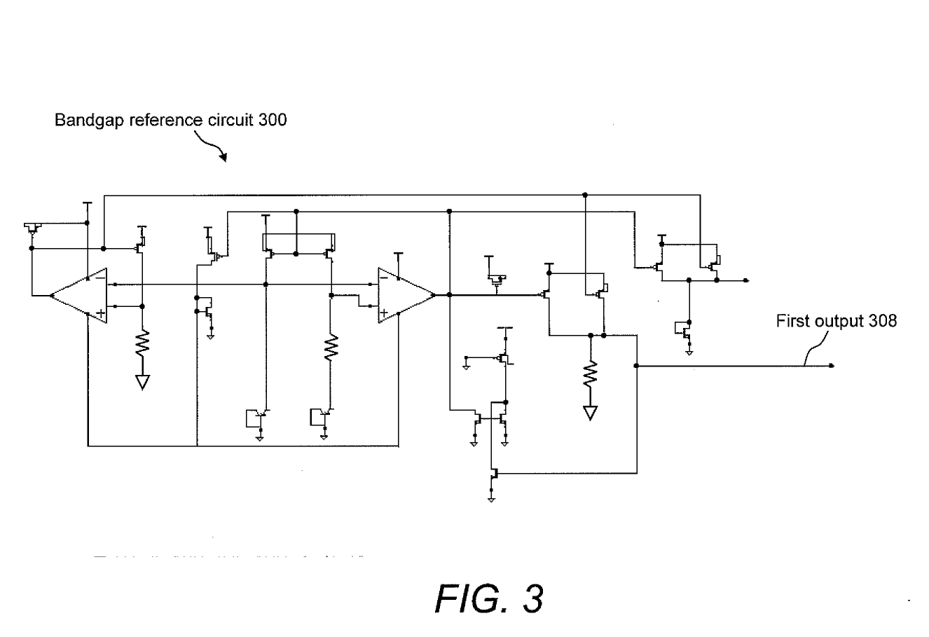

Referring next to FIG. 3, and also FIGS. 1 and 2, an embodiment of a bandgap reference circuit 300, e.g., bandgap reference circuit 112 (FIG. 1) and bandgap reference circuit 212 (FIG. 2), is illustrated. In this embodiment, bandgap reference circuit 300 generates a first output 308, discussed in detail previously.

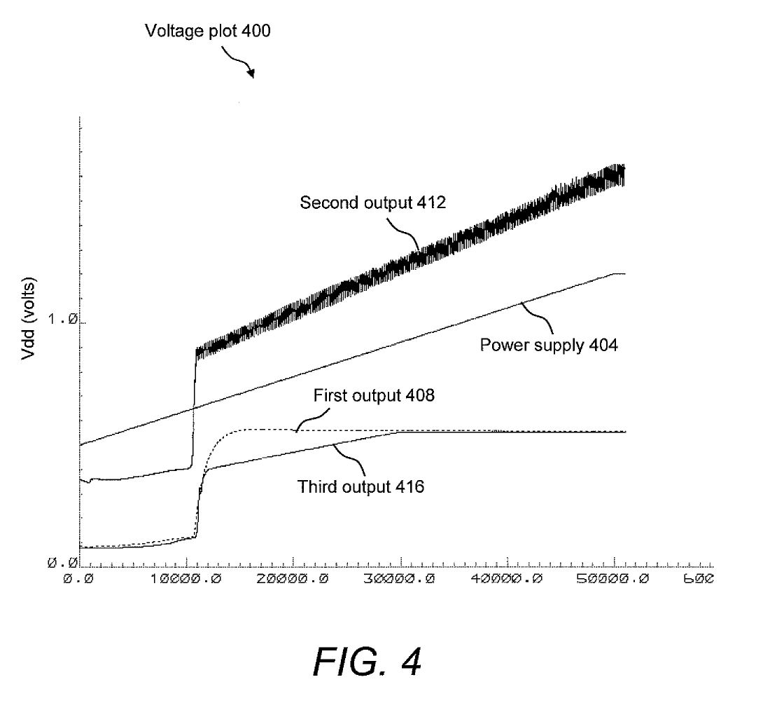

Referring back to the drawings, FIG. 4 illustrates a simulation result from an embodiment of a system 400. In general, system 400 includes a power supply 404, such as, for example, Vdd. System 400 may also include a first output 408, a second output 412 and a third output 416. In one example, an increase in the value of power supply 404, e.g., Vdd, from 0.6 V to 1.4 V results in second output 412 having a value that may follow the equation (1.3*Vdd). First output 408 may level off at 0.55 V when second output 412 reaches approximately 0.9 V. Accordingly, third output 416 may have a value that follows the equation (0.61*Vdd) until Vdd equals 0.9 V, at which point third output 416 may be clamped at 0.55 V.

In another example, third output 416 may be used to scale the limits of pumped supplies, such as, for example, a boosted wordline level (Vpp) (not shown) or a negative Pwell level (Vbb) (not shown), recognized by those of ordinary skill and associated with an ASIC eDRAM macro. Without a scaled reference level, such as third output 416, a pumped supply such as the Vpp (not shown) level for an eDRAM array may never reach its regulated target level because if the target level is a fixed DC voltage, a 2× pump, for example, may not have the capacity to attain that target at low Vdd voltages. This failure may inadvertently cause an interrupt in the power-on sequence or lead to an indeterminate pumped supply level that causes low-voltage tests to become unreliable. Likewise, p-type differential op-amps may also cut-off if their target level approaches Vdd. A scaled reference, however, may permit operation of op-amps at lower values of Vdd, while providing a reference level at higher values of Vdd for a regulated, maximum value clamp. In yet another example, in an ASIC eDRAM offering. Vpp (not shown) may be scaled to a value equal to the equation (3.0*third output 416) when Vdd is greater than 0.9 V. If Vdd falls below 0.9 V, third output 416 is scaled to a value equal to the equation (0.61*Vdd). Accordingly, Vpp (not shown) may be scaled to a value equal to the equation (1.83*Vdd). This scaling keeps the pumped voltage target below the theoretical limit for a single stage pump, e.g., a 2× single stage pump, and allows the Vpp system (not shown) to power up to a predictable reduced level before power supply 104 has reached its final level.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A voltage reference system comprising:
a bandgap reference circuit having a first output; and
a voltage pumping circuit having a second output providing a power supply to the bandgap reference circuit.

2. A system according to claim 1, further comprising a regulator circuit that regulates said voltage pumping circuit by a comparison of a fraction of said second output and a first fraction of Vdd, said second output being a value greater than Vdd.

3. A system according to claim 1, further comprising a clamping circuit in electrical communication with said first output, said clamping circuit having a third output that is the minimum of said first output and a second fraction of Vdd.

4. A system according to claim 3, wherein said clamping circuit includes a voltage divider configured to provide said second fraction of Vdd.

5. A system according to claim 2, further comprising a clamping circuit in electrical communication with said first output, said clamping circuit having a third output that is the minimum of said first output and a second fraction of Vdd.

6. A system according to claim 1, wherein said voltage pumping circuit is a 2× pumping circuit.

7. A system according to claim 5, wherein said second output is about 1.3 times Vdd, said first fraction of Vdd is about 0.55 times Vdd, and said second fraction is about 0.61 times Vdd.

8. A voltage reference system comprising:
a voltage pumping circuit having a first output;
a regulator circuit for regulating said voltage pumping circuit by a comparison of a fraction of said first output and a first fraction of Vdd, said first output being a value greater than Vdd;
a bandgap reference circuit having a second output, said bandgap reference circuit having a power supply provided by said first output; and
a clamping circuit in electrical communication with said second output, said clamping circuit having a third output that is the minimum of said second output and a second fraction of Vdd.

9. A system according to claim 8, wherein said first output is about 1.3 times Vdd, said first fraction of Vdd is about 0.55 times Vdd, and said second fraction is about 0.61 times Vdd.
